(19) United States
(12) Patent Application Publication
(10) Pub. No.: US 2025/0214035 A1
(43) Pub. Date: Jul. 3, 2025

(54) CARBON DIOXIDE CAPTURING APPARATUS AND CAPTURING METHOD

(71) Applicant: KOREA RESEARCH INSTITUTE OF CHEMICAL TECHNOLOGY, Daejeon (KR)

(72) Inventors: Yong Ki PACK, Daejeon (KR); Ki-Woong KIM, Daejeon (KR); Dae Jin KIM, Daejeon (KR)

(73) Assignee: KOREA RESEARCH INSTITUTE OF CHEMICAL TECHNOLOGY, Daejeon (KR)

(21) Appl. No.: 18/717,805

(22) PCT Filed: Jan. 31, 2023
(86) PCT No.: PCT/IB2023/050818

§ 371 Date: Mar. 10, 2025

(30) Foreign Application Priority Data
Dec. 10, 2021 (KR) 10-2021-0176528

(51) Int. Cl. B01D 53/62; B01D 53/12; B01D 53/83; B01D 53/96

(52) U.S. Cl. CPC B01D 53/62; B01D 53/12; B01D 53/83; B01D 53/96; B01D 2253/102; B01D 2253/108; B01D 2257/504; B01D 2258/02; B01D 2259/40088

(57) ABSTRACT

One embodiment of a carbon dioxide capturing apparatus according to the present invention comprises: an absorption column comprising a carbon dioxide adsorption or carbon dioxide absorption part for adsorbing or absorbing carbon dioxide from an exhaust gas; a regeneration column connected to the absorption column and comprising an adsorbent heating part, which is for heating an adsorbent circulating the inside thereof, and an absorbent heating part which is for heating an absorbent circulating the inside thereof; and the adsorbent or absorbent circulating the absorbent column and the regeneration column to alternately perform adsorption and desorption of carbon dioxide or absorption and desorption of carbon dioxide. The carbon dioxide capturing apparatus is characterized in that: a line is branched from a first dynamic-pressure gas line connecting a line, for carbon dioxide desorbed in the regeneration column, and an absorption column hopper, so as to supply a low density oxygen gas to the absorption column hopper; and a line is branched from a second dynamic-pressure gas line connecting a line, for discharging a carbon dioxide-removed exhaust gas to the outside through the upper end of the absorption column, and a regeneration column hopper, so as to supply a low density oxygen gas to the regeneration column hopper.

### CROSS REFERENCE TO RELATED APPLICATION

The present application claims priority to Korean Patent Applications No. 10-2021-0176528, filed on Dec. 10, 2021, and the entire contents of which are incorporated herein for all purposes by this reference.

### BACKGROUND

### Technical Field

The present disclosure relates to an apparatus and process for capturing of carbon dioxide and, in detail, carbon dioxide capturing apparatus and capturing method that can remove flow instability due to congestion of an absorbent in an absorption column hopper and a regeneration column hopper.

### Description of the Related Art

Recently, the sea level is increasing with melting of glaciers at the polar regions due to global warming and extreme weather occurs in place after place of the earth due to climate change.

Such global warming has been known as contributing to emission of greenhouse gases such as carbon dioxide.

International agreements have been made to regulate carbon dioxide emissions and it becomes an economic issue of every country to suppress emission of carbon dioxides by introducing a carbon credit.

The efforts of reducing carbon dioxide emissions progress in a way of developing alternative energy that can replace fossil energy such as solar energy and wind energy and in a way of capturing and storing carbon dioxide produced from fossil fuel not discharging it to the atmosphere.

The latter technology is called carbon capture and storage (CCS) and is, in a broad meaning, classified into a technology of the field of capturing carbon dioxide produced at power plants or steelworks and a technology of storing captured carbon dioxide under the ground or the sea.

A technology of capturing carbon dioxide can be classified into post-burning capturing, pre-burning capturing, and pure oxygen capturing in accordance with application of capturing stages. Further, the technology can be classified, in accordance with the principles of capturing carbon dioxide, into membrane separation that condenses carbon dioxide using a separation membrane, liquid phase separation that uses a liquid absorbent such as amine or ammonia, and solid phase separation that uses a solid phase absorbent such as alkali or alkali earth metal.

The solid phase separation of the technologies of capturing carbon dioxide is, in a broad meaning, composed of a process of developing a solid phase absorbent having a carbon dioxide adsorption ability and a process of capturing carbon dioxide using the solid phase absorbent, and the efficiency of capturing carbon dioxide is greatly influenced by not only the performance of a solid phase absorbent, but the configuration of an adsorption process.

Solid phase absorbents are classified, in accordance with the kinds of the substances, into organic, inorganic, carbon-based, organic-inorganic hybrid, etc. solid phase absorbents, and are classified, in accordance with the type of absorption into an absorbent, into a physical absorbent, a chemical absorbent, etc.

A process of capturing carbon dioxide using such solid phase absorbents, which is a method of desorbing absorbed carbon dioxide, can be classified, in a broad meaning, into Pressure Swing Adsorption (PSA) and Temperature Swing Adsorption (TSA) that use a pressure difference and a temperature difference.

In general, pressure swing adsorption that uses a fixed-bed absorption column is advantageous for small-scale carbon dioxide capturing, but when a large amount of carbon dioxide is discharged such as at a power plant or a large combustion furnace, temperature swing adsorption composed of fluidized-bed absorption and desorption columns that can be easily scaled up is advantageous.

Korean Patent Application Publication No. 2005-0003767, Korean Patent Application Publication No. 2010-0099929, etc. that are prior art document relevant to this have proposed a carbon dioxide capturing process of a temperature swing adsorption concept composed of an absorption column and a desorption column to capture carbon dioxide using a solid phase dry absorbent.

However, such a dry capturing process of a temperature swing adsorption concept consumes a great amount of energy to desorb carbon dioxide absorbed in an absorbent, so it acts as a factor that increases the cost for an absorbent and a capturing cost.

Accordingly, an apparatus and process for capturing carbon dioxide designed to reduce a capturing cost by effectively desorbing absorbed carbon dioxide from an absorbent with less energy has been proposed in Korean Patent No. 10-2033745.

FIG. 1 is a view showing an apparatus for capturing carbon dioxide according to the related art (Korean Patent No. 10-2033745).

In the apparatus for capturing carbon dioxide shown in FIG. 1, it is possible to remove flow instability due to congestion of an absorbent only when supplying a fluidizing gas into a reaction column (absorption column) hopper and a desorption column (regeneration column) to fluidize the absorbent.

Absorbents have the problem that their performance decreases when they come in contact with oxygen at a temperature of about 80° C. or more for the characteristics thereof.

Further, since the flash temperature of Poly Ethylene Imine (PEI) that is a main component of absorbents is 110° C., it is possible to secure operation stability only when preventing contact with high-concentration oxygen at a high temperature.

To this end, it is required to maintain the oxygen concentration at a low level in a hopper.

### SUMMARY

One embodiment of a carbon dioxide capturing apparatus according to the present invention comprise; an absorption column comprising a carbon dioxide adsorption part or carbon dioxide absorption part for adsorbing or adsorbing carbon dioxide from an exhaust gas; a regeneration column connected to the absorption column and comprising an adsorbent heating part, which is for heating an adsorbent circulating the inside thereof, and the adsorbent or absorbent circulating the absorbent.

The present disclosure has been made in an effort to solve the problems of the related art described above and an objective of the present disclosure is to provide an apparatus and process for capturing of carbon dioxide that can remove flow instability due to congestion of an absorbent in an absorption column hopper and a regeneration column hopper.

In order to achieve the objectives described above, an embodiment of an apparatus for capturing of carbon dioxide according to a first aspect of the present disclosure includes: an absorption column that includes a carbon dioxide adsorber or a carbon dioxide absorber that adsorbs or absorbs carbon dioxide from exhaust gas; a regeneration column that is connected with the absorption column and includes an adsorbent heater that heats an adsorbent circulating therein or an absorbent heater that heats an absorbent circulating therein; and an adsorbent or an absorbent that alternately performs adsorption of carbon dioxide and desorption of carbon dioxide or absorption of carbon dioxide and desorption of carbon dioxide while circulating through the absorption column and the regeneration column, wherein the apparatus is configured to diverge from a first equalizing gas line, which connects a line for carbon dioxide desorbed through the regeneration column and an absorption column hopper, and supply low-concentration oxygen gas to the absorption column hopper, and the apparatus is configured to diverge from a second equalizing gas line, which connects a line for discharging exhaust gas with carbon dioxide removed that is discharged outside through an upper end of the absorption column and the regeneration column hopper, and supply low-concentration oxygen gas to the regeneration column hopper.

Gas partially diverges after passing through a first valve from the first equalizing gas line at the upper end of the absorption column hopper, sequentially passes through a first particle filter and a first pressure booster, and is then reused as a fluidizing gas at a lower portion of the absorption column hopper through a first flowmeter.

In this case, it is preferable that the first pressure booster is a blower.

Further, some new fluidizing gas may be fed at the outlet line of the first pressure booster for an insufficient fluidizing gas of the absorption column hopper.

Further, gas partially diverges after passing through a second valve from the second equalizing gas line at the upper end of the regeneration column hopper, sequentially passes through a second particle filter and a second pressure booster, and is then reused as a fluidizing gas at a lower portion of the regeneration column hopper through a second flowmeter.

In this case, it is preferable that the second pressure booster is a blower.

Further, some new fluidizing gas may be fed at the outlet line of the second pressure booster for an insufficient fluidizing gas of the regeneration column hopper.

Further, a fluidizing gas at the upper end of the absorption column hopper is at the same pressure as the carbon dioxide line, so when a fluidizing gas of low-concentration oxygen flows to carbon dioxide, it causes reduction of concentration of carbon dioxide, and accordingly, a inlet line of the first pressure booster is maintained at a negative pressure such that a portion of carbon dioxide gas flows to the fluidizing gas in order to prevent reduction of concentration of carbon dioxide due to the fluidizing gas.

Another embodiment of the apparatus for capturing of carbon dioxide according to the first aspect of the present disclosure includes: an absorption column that includes a carbon dioxide adsorber or a carbon dioxide absorber that adsorbs or absorbs carbon dioxide from exhaust gas; a regeneration column that is connected with the absorption column and includes an adsorbent heater that heats an adsorbent circulating therein or an absorbent heater that heats an absorbent circulating therein; and an adsorbent or an absorbent that alternately performs adsorption of carbon dioxide and desorption of carbon dioxide or absorption of carbon dioxide and desorption of carbon dioxide while circulating through the absorption column and the regeneration column, wherein the apparatus is configured to diverge from a first equalizing gas line, which connects a line for carbon dioxide desorbed through the regeneration column and an absorption column hopper, and supply low-concentration oxygen gas to the absorption column hopper.

Gas partially diverges after passing through a first valve from the first equalizing gas line at the upper end of the absorption column hopper, sequentially passes through a first particle filter and a first pressure booster, and is then reused as a fluidizing gas at a lower portion of the absorption column hopper through a first flowmeter, and it is preferable that some new fluidizing gas is fed at the outlet line of the first pressure booster for an insufficient fluidizing gas of the absorption column hopper.

Meanwhile, an embodiment of a process for capturing of carbon dioxide according to a second aspect of the present disclosure is a process for capturing of carbon dioxide that includes: adsorbing carbon dioxide or absorbing carbon dioxide from exhaust gas at an absorption column; and alternately performing adsorption of carbon dioxide and desorption of carbon dioxide or absorption of carbon dioxide and desorption of carbon dioxide while an adsorbent or an absorbent circulates in a regeneration column and the absorption column that include a heater for heating the adsorbent or the absorbent circulating therein, wherein gas diverges from a first equalizing gas line, which connects a line for carbon dioxide desorbed through the regeneration column and an absorption column hopper, to supply low-concentration oxygen gas to the absorption column hopper, and gas diverges from a second equalizing gas line, which connects a line for discharging exhaust gas with carbon dioxide removed that is discharged outside through an upper end of the absorption column and the regeneration column hopper, to supply low-concentration oxygen gas to the regeneration column hopper.

Alternatively, another embodiment of the process for capturing of carbon dioxide according to the second aspect of the present disclosure is a process for capturing of carbon dioxide that includes: adsorbing carbon dioxide or absorbing carbon dioxide from exhaust gas at an absorption column; and alternately performing adsorption of carbon dioxide and desorption of carbon dioxide or absorption of carbon dioxide and desorption of carbon dioxide while an adsorbent or an absorbent circulates in a regeneration column and the absorption column that include a heater for heating the adsorbent or the absorbent circulating therein, wherein gas diverges from a first equalizing gas line, which connects a line for carbon dioxide desorbed through the regeneration column and an absorption column hopper, to supply low-concentration oxygen gas to the absorption column hopper.

Details of other embodiments are included in detailed description of the invention” and the accompanying “drawings”.

The advantages and/or features of the present disclosure, and methods of achieving them will be clear by referring to the exemplary embodiments that will be describe hereafter in detail with reference to the accompanying drawings.

However, it should be noted that the present disclosure is not limited to the configuration of each of embodiments to be described hereafter and may be implemented in various ways, and the exemplary embodiments described in the specification are provided to complete the description of the present disclosure and let those skilled in the art completely know the scope of the present disclosure and the present disclosure is defined by claims.

According to the summary, the present disclosure has the following effects.

The present disclosure is configured to diverge from a second equalizing gas line, which connects a line for discharging exhaust gas with carbon dioxide removed that is discharged outside through the upper end of an absorption column and a regeneration column hopper, and supply low-concentration oxygen gas to the regeneration column hopper, and is configured to diverge from a first equalizing gas line, which connects a line for carbon dioxide desorbed through a regeneration column and an absorption column hopper, and supply low-concentration oxygen gas to the absorption column hopper, so low-concentration oxygen gas is used as a fluidizing gas. Accordingly, there is an effect that it is possible to remove flow instability due to congestion of an absorbent in the absorption column hopper and the regeneration column hopper.

Further, there is the advantage that it is possible to reduce the cost for supplying low-concentration oxygen gas when reusing a fluidizing gas.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is a view showing an apparatus for capturing of carbon dioxide according to the related art;

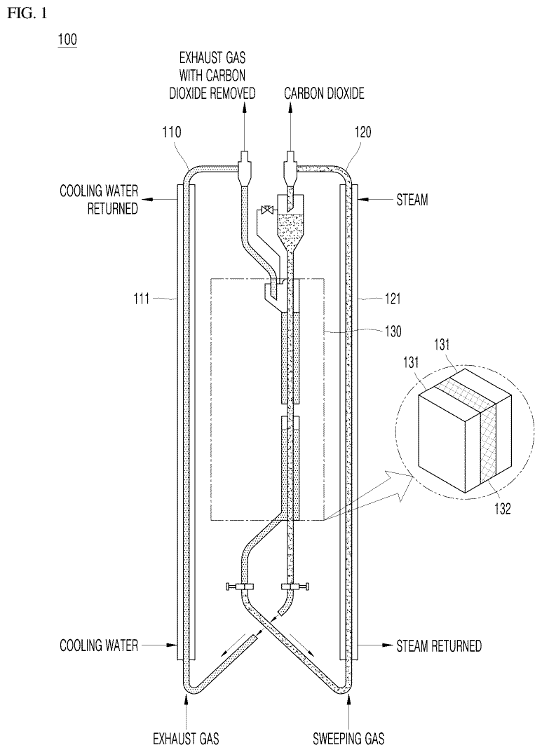

FIG. 2 is a view schematically showing the configuration of an apparatus for capturing of carbon dioxide according to an embodiment of the present disclosure;

FIG. 3 is a view showing the apparatus for capturing of carbon dioxide according to an embodiment of the present disclosure; and

FIG. 4 is a view showing an apparatus for capturing of carbon dioxide according to another embodiment of the present disclosure.

### DETAILED DESCRIPTION

An embodiment of an apparatus for capturing of carbon dioxide of the present disclosure provides an apparatus for capturing of carbon dioxide and a process for capturing of carbon dioxide, the apparatus including: an absorption column that includes a carbon dioxide adsorber or a carbon dioxide absorber that adsorbs or absorbs carbon dioxide from exhaust gas; a regeneration column that is connected with the absorption column and includes an adsorbent heater that heats an adsorbent circulating therein or an absorbent heater that heats an absorbent circulating therein; and an adsorbent or an absorbent that alternately performs adsorption of carbon dioxide and desorption of carbon dioxide or absorption of carbon dioxide and desorption of carbon dioxide while circulating through the absorption column and the regeneration column, wherein the apparatus is configured to diverge from a first equalizing gas line, which connects a line for carbon dioxide desorbed through the regeneration column and an absorption column hopper, and supply low-concentration oxygen gas to the absorption column hopper, and the apparatus is configured to diverge from a second equalizing gas line, which connects a line for discharging exhaust gas with carbon dioxide removed that is discharged outside through an upper end of the absorption column and the regeneration column hopper, and supply low-concentration oxygen gas to the regeneration column hopper, whereby it is possible to remove flow instability due to congestion of an absorbent in the absorption column hopper and the regeneration column hopper.

Hereafter, preferred embodiments of the present disclosure are described in detail with reference to the accompanying drawings.

Before describing the present disclosure in detail, terms or words used herein should not be construed as being limited to common or dictionary meanings, the concepts of various terms may be appropriately defined to the most optimally describe the invention by the inventor(s), and it should be noted that those terms or words should be construed as meanings and concepts corresponding to the technical spirit of the present disclosure.

That is, it should be noted that the terms used herein are used only to describing preferred embodiments of the present disclosure, not intending to limit the present disclosure in detail, and those terms are terms defined in consideration of various possibilities of the present disclosure.

Further, it should be noted that, in the specification, singular expression may include plural expression unless clearly stated in the sentences, and includes a singular meaning even if it is similarly expressed as a plural number.

It should be noted that when a component is described as “including” another component throughout the specification, the component may further include another component without another component excluded, unless specifically stated otherwise.

Further, it should be noted that when a component is described as “exists in” and “is connected to” another component, the component may be directly connected with another component, may be installed in contact with another component, or may be installed with a predetermined gap. When the component is installed with a gap, there may be a third component or means for fixing and connecting the component to another component, and the third component or means may not be described.

On the other hands, it should be understood that when a component is described as “directly connected” or “indirectly connected” to another component, it should be construed as there is no third component or means.

Similarly, the terms used herein to describe a relationship between elements, that is, “between”, “directly between”, “adjacent” or “directly adjacent” should be interpreted in the same manner as those described above.

Further, in the specification, it should be noted that terms such as “first side”, “second side”, “first”, and “second”, if used, are used to clearly discriminate one components from another component and the meaning of the corresponding component is not limited by the terms.

Further, terms related to positions such as “up”, “down”, “left”, and “right”, if used herein, should be construed as indicating relative positions of corresponding components in the corresponding figures and should not be construed as stating absolute positions unless the absolute positions of them are specified.

Further, it should be noted that, in the specification, terms such as “˜part”, “˜er”, “module”, and “device”, if used, mean a unit that can perform one or more functions or operations and may be implemented by hardware, software, or a combination of hardware and software.

Further, in the specification, when components are given reference numerals, the same reference numerals are given to same components even if they are shown in different figures, that is, same reference numerals indicate same components throughout the specification.

The size, position, coupling relationship, etc. of components of the present disclosure may be partially exaggerated or reduced in the accompanying drawings for the convenience of description in order to sufficiently and clearly transmit the spirit of the present disclosure, so the proportion or scale may not be precise.

Further, in the following description of the present disclosure, components that are determined to unclearly make the spirit of the present disclosure unclear, for example, well-known technology including the related art may not be described in detail.

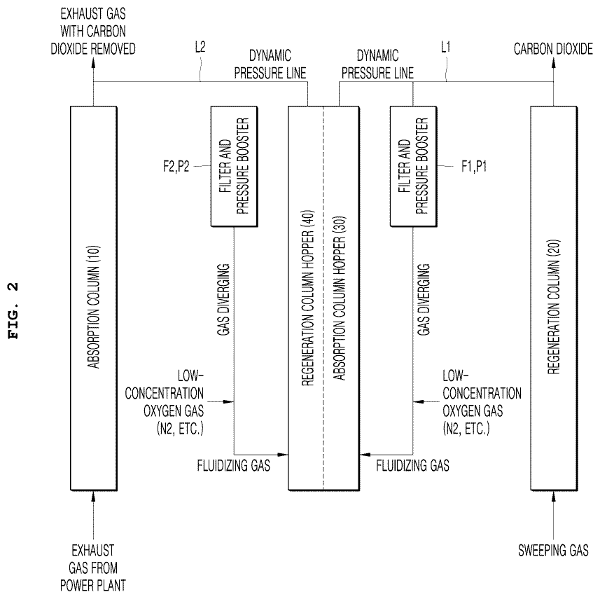

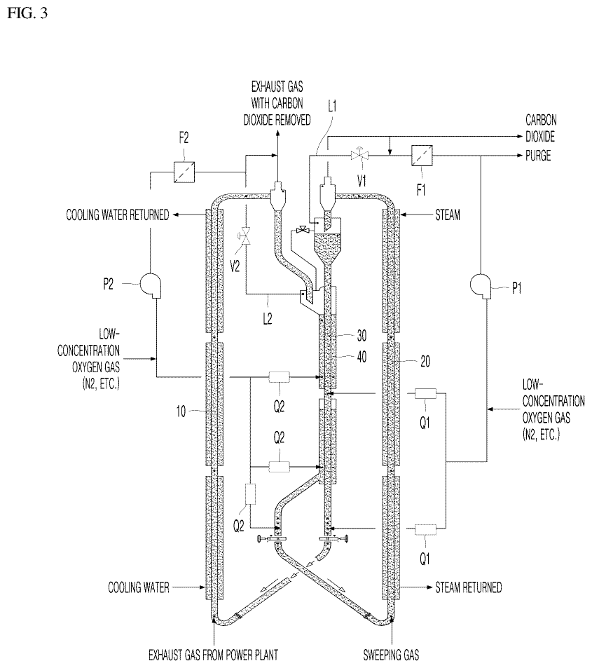

FIG. 2 is a view schematically showing the configuration of an apparatus for capturing of carbon dioxide according to an embodiment of the present disclosure and FIG. 3 is a view showing the apparatus for capturing of carbon dioxide according to an embodiment of the present disclosure.

An apparatus for capturing of carbon dioxide according to the present disclosure includes an absorption column 10, a regeneration column 20, and an adsorbent or an absorbent, uses sensible heat that the adsorbent or the absorbent has when the adsorbent or the absorbent circulates through the absorption column 10 and the regeneration column 20, and can increase energy efficiency by inducing direct or indirect heat exchange between adsorbents or absorbents.

The absorption column 10 includes a carbon dioxide adsorber or a carbon dioxide absorber that adsorbs or absorbs carbon dioxide from exhaust gas.

The regeneration column 20 includes an adsorbent heater that heats the adsorbent circulating therein or an absorbent heater that heats the absorbent circulating therein.

The absorption column 10 and the regeneration column 20 are connected to each other and are filled with an adsorbent or an absorbent circulating therein, and adsorption and desorption of carbon dioxide or absorption and desorption of carbon dioxide are alternately repeated therein.

An adsorbent or an absorbent alternately performs adsorption of carbon dioxide and desorption of carbon dioxide or absorption of carbon dioxide and desorption of carbon dioxide while circulating through the absorption column 10 and the regeneration column 20.

In this case, adsorption means physical combination of gas-state carbon dioxide and a solid phase adsorbent and absorption means chemical combination of gas-state carbon dioxide and a solid phase absorbent, and they may be discriminated in accordance with the type of adsorption or absorption.

The adsorbent may be one or more kinds selected from a group of a zeolite-based adsorbent and a carbon-based adsorbent.

The absorbent may be one or more kinds selected from a group of porous silica absorbents grafted with organics having an amine group.

Other details of the absorption column, the regeneration column, the adsorbent, and the absorbent of the apparatus for capturing of carbon dioxide are described in detail in Korean Patent No. 10-2033745 by the applicant(s), so description thereof is omitted.

The present disclosure is characterized by being configured to diverge from a first equalizing gas line L1, which connects a line for carbon dioxide desorbed through the regeneration column 20 and an absorption column hopper 30, and supply low-concentration oxygen gas to the absorption column hopper 30 and being configured to diverge from a second equalizing gas line L2, which connects a line for discharging exhaust gas with carbon dioxide removed that is discharged outside through the upper end of the absorption column 10 and the regeneration column hopper 40, and supply low-concentration oxygen gas to the regeneration column hopper 40.

Gas partially diverges after passing through a first valve V1 from the first equalizing gas line L1 described above at the upper end of the absorption column hopper 30, sequentially passes through a first particle filter F1 and a first pressure booster P1, and is then reused as a fluidizing gas at the lower portion of the absorption column hopper 30 through a first flowmeter Q1.

In this case, it is preferable that the first pressure booster P1 is a blower.

Further, some new fluidizing gas may be fed at the outlet line of the first pressure booster P1 for the insufficient fluidizing gas of the absorption column hopper 30.

Further, gas partially diverges after passing through a second valve V2 from the second equalizing gas line L2 at the upper end of the regeneration column hopper 40, sequentially passes through a second particle filter F2 and a second pressure booster P2, and is then reused as a fluidizing gas at the lower portion of the regeneration column hopper 40 through a second flowmeter Q2.

In this case, it is preferable that the second pressure booster P2 is a blower.

Further, new fluidizing gas may be supplied at the outlet line of the second pressure booster P2 for the insufficient fluidizing gas of the regeneration column hopper 40.

The fluidizing gas at the upper end of the absorption column hopper 30 described above is at the same pressure as the carbon dioxide line, so when a fluidizing gas of low-concentration oxygen flows to carbon dioxide, it causes reduction of concentration of carbon dioxide. Accordingly, the inlet line of the first pressure booster P1 is maintained at a negative pressure such that a portion of carbon dioxide gas flows to the fluidizing gas in order to prevent reduction of concentration of carbon dioxide due to a fluidizing gas.

A process for capturing of carbon dioxide using the apparatus for capturing of carbon dioxide having the configuration described above adsorbs carbon dioxide or absorbs carbon dioxide from exhaust gas of a power plant, etc. at the absorption column 10, alternately performs adsorption of carbon dioxide and desorption of carbon dioxide or absorption of carbon dioxide and desorption of carbon dioxide while an adsorbent or an absorbent circulates in the regeneration column 20 and the absorption column 10 that include a heater for heating the adsorbent or the absorbent circulating therein, in which gas diverges from the first equalizing gas line L1, which connects a line for carbon dioxide desorbed through the regeneration column 20 and the absorption column hopper 30, to supply low-concentration oxygen gas to the absorption column hopper 30 and gas diverges from the second equalizing gas line L2, which connects a line for discharging exhaust gas with carbon dioxide removed that is discharged outside through the upper end of the absorption column 10 and the regeneration column hopper 40, to supply low-concentration oxygen gas to the regeneration column hopper 40.

As described above, the present disclosure is configured to diverge from a second equalizing gas line L2, which connects a line for discharging exhaust gas with carbon dioxide removed that is discharged outside through the upper end of the absorption column 10 and the regeneration column hopper 40, and supply low-concentration oxygen gas to the regeneration column hopper 40, and is configured to diverge from the first equalizing gas line L1, which connects a line for carbon dioxide desorbed through the regeneration column 20 and an absorption column hopper 30, and supply low-concentration oxygen gas to the absorption column hopper 30, so low-concentration oxygen gas is used as a fluidizing gas. Accordingly, there are the advantages that it is possible to remove flow instability due to congestion of an absorbent in the absorption column hopper 30 and the regeneration column hopper 40 and it is possible to reduce the cost for supplying low-concentration oxygen gas when reusing a fluidizing gas.

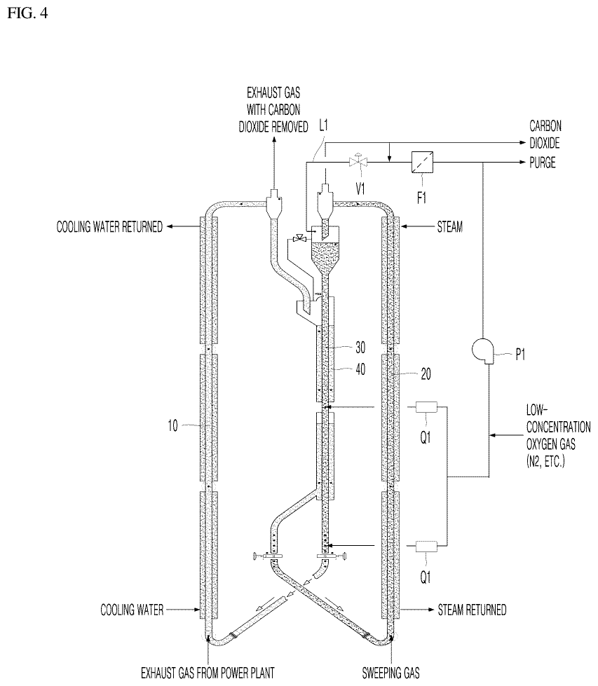

FIG. 4 is a view showing an apparatus for capturing of carbon dioxide according to another embodiment of the present disclosure.

An apparatus for capturing of carbon dioxide according to the present disclosure includes an absorption column 10, a regeneration column 20, and an adsorbent or an absorbent, uses sensible heat that the adsorbent or the absorbent has when the adsorbent or the absorbent circulates through the absorption column 10 and the regeneration column 20, and can increase energy efficiency by inducing direct or indirect heat exchange between adsorbents or absorbents.

The absorption column 10 includes a carbon dioxide adsorber or a carbon dioxide absorber that adsorbs or absorbs carbon dioxide from exhaust gas.

The regeneration column 20 includes an adsorbent heater that heats the adsorbent circulating therein or an absorbent heater that heats the absorbent circulating therein.

The absorption column 10 and the regeneration column 20 are connected to each other and are filled with an adsorbent or an absorbent circulating therein, and adsorption and desorption of carbon dioxide or absorption and desorption of carbon dioxide are alternately repeated therein.

An adsorbent or an absorbent circulates through the absorption column 10 and the regeneration column 20, and adsorption of carbon dioxide and desorption of carbon dioxide or absorption of carbon dioxide and desorption of carbon dioxide are alternately performed.

In this case, adsorption means physical combination of gas-state carbon dioxide and a solid phase adsorbent and absorption means chemical combination of gas-state carbon dioxide and a solid phase absorbent, and they may be discriminated in accordance with the type of adsorption or absorption.

The adsorbent may be one or more kinds selected from a group of a zeolite-based adsorbent and a carbon-based adsorbent.

The absorbent may be one or more kinds selected from a group of porous silica absorbents grafted with organics having an amine group.

High-temperature particles coming out of the regeneration column 20 flows into the absorption column hopper 30 through a cyclone.

Accordingly, since the absorption column hopper 30 is higher in temperature than the regeneration column hopper 40, when a fluidizing gas containing oxygen flows inside, the performance of the absorbent decreases.

Accordingly, the regeneration column hopper 40 does not allow a fluidizing gas to diverge and only the absorption column hopper 30 can reuse a fluidizing gas.

Accordingly, the present disclosure is characterized by being configured to diverge from the first equalizing gas line L1, which connects a line for carbon dioxide desorbed through the regeneration column 20 and the absorption column hopper 30, and supply low-concentration oxygen gas to an absorption column hopper 30.

Gas partially diverges after passing through the first valve V1 from the first equalizing gas line L1 described above at the upper end of the absorption column hopper 30, sequentially passes through a first particle filter F1 and a first pressure booster P1, and is then reused as a fluidizing gas at the lower portion of the absorption column hopper through a first flowmeter Q1, and it is preferable that some new fluidizing gas is fed at the outlet line of the first pressure booster P1 for the insufficient fluidizing gas of the absorption column hopper 30.

The fluidizing gas at the upper end of the absorption column hopper 30 described above is at the same pressure as the carbon dioxide line, so when a fluidizing gas of low-concentration oxygen flows to carbon dioxide, it causes reduction of concentration of carbon dioxide. Accordingly, the inlet line of the first pressure booster P1 is maintained at a negative pressure such that a portion of carbon dioxide gas flows to the fluidizing gas in order to prevent reduction of concentration of carbon dioxide due to a fluidizing gas.

The process for capturing of carbon dioxide using the apparatus for capturing of carbon dioxide having the configuration described above includes adsorbing carbon dioxide or absorbing carbon dioxide from exhaust gas at the absorption column 10, and alternately performing adsorption of carbon dioxide and desorption of carbon dioxide or absorption of carbon dioxide and desorption of carbon dioxide while an adsorbent or an absorbent circulates in the regeneration column 20 and the absorption column 10 that include a heater for heating the adsorbent or the absorbent circulating therein, in which gas diverges from the first equalizing gas line L1, which connects a line for carbon dioxide desorbed through the regeneration column 20 and the absorption column hopper 30, to supply low-concentration oxygen gas to the absorption column hopper 30.

Various preferred embodiments of the present disclosure were described above through some examples, but the various embodiments described in “detailed description of the invention” are only examples and it would be clearly understood by those skilled in the art the present disclosure may be changed in various ways or equivalently implemented from the above description.

Further, it should be noted that since the present disclosure may be implemented in other various ways, the present disclosure is not limited to the above description, the above description is provided to completely explain the present disclosure and provided only to completely inform those skilled in the art of the range of the present disclosure, and the present disclosure is defined by only claims.

The present disclosure has industrial applicability in that it provides an apparatus and process for capturing of carbon dioxide that is configured to diverge from a second equalizing gas line, which connects a line for discharging exhaust gas with carbon dioxide removed that is discharged outside through the upper end of an absorption column and a regeneration column hopper, and supply low-concentration oxygen gas to the regeneration column hopper, and is configured to diverge from a first equalizing gas line, which connects a line for carbon dioxide desorbed through a regeneration column and an absorption column hopper, and supply low-concentration oxygen gas to the absorption column hopper, so low-concentration oxygen gas is used as a fluidizing gas, whereby there is an effect that it is possible to remove flow instability due to congestion of an absorbent in the absorption column hopper and the regeneration column hopper.

1. An apparatus for capturing of carbon dioxide, comprising:
an absorption column that includes a carbon dioxide adsorber or a carbon dioxide absorber that adsorbs or absorbs carbon dioxide from exhaust gas;
a regeneration column that is connected with the absorption column and includes an adsorbent heater that heats an adsorbent circulating therein or an absorbent heater that heats an absorbent circulating therein; and
an adsorbent or an absorbent that alternately performs adsorption of carbon dioxide and desorption of carbon dioxide or absorption of carbon dioxide and desorption of carbon dioxide while circulating through the absorption column and the regeneration column,
wherein the apparatus is configured to diverge from a first equalizing gas line, which connects a line for carbon dioxide desorbed through the regeneration column and an absorption column hopper, and supply low-concentration oxygen gas to the absorption column hopper, and
the apparatus is configured to diverge from a second equalizing gas line, which connects a line for discharging exhaust gas with carbon dioxide removed that is discharged outside through an upper end of the absorption column and the regeneration column hopper, and supply low-concentration oxygen gas to the regeneration column hopper.

2. The apparatus of claim 1, wherein gas partially diverges after passing through a first valve from the first equalizing gas line at the upper end of the absorption column hopper, sequentially passes through a first particle filter and a first pressure booster, and is then reused as a fluidizing gas at a lower portion of the absorption column hopper through a first flowmeter.

3. The apparatus of claim 1, wherein the first pressure booster is a blower.

4. The apparatus of claim 3, wherein some new fluidizing gas may be fed at a outlet line of the first pressure booster for an insufficient fluidizing gas of the absorption column hopper.

5. The apparatus of claim 1, wherein gas partially diverges after passing through a second valve from the second equalizing gas line at the upper end of the regeneration column hopper, sequentially passes through a second particle filter and a second pressure booster, and is then reused as a fluidizing gas at a lower portion of the regeneration column hopper through a second flowmeter.

6. The apparatus of claim 5, wherein the second pressure booster is a blower.

7. The apparatus of claim 6, wherein some new fluidizing gas may be fed at a outlet line of the second pressure booster for an insufficient fluidizing gas of the regeneration column hopper.

8. The apparatus of claim 2, wherein a fluidizing gas at the upper end of the absorption column hopper is at the same pressure as the carbon dioxide line, so when a fluidizing gas of low-concentration oxygen flows to carbon dioxide, it causes reduction of concentration of carbon dioxide, and accordingly, a inlet line of the first pressure booster is maintained at a negative pressure such that a portion of carbon dioxide gas flows to the fluidizing gas in order to prevent reduction of concentration of carbon dioxide due to the fluidizing gas.

9. An apparatus for capturing of carbon dioxide, comprising:
an absorption column that includes a carbon dioxide adsorber or a carbon dioxide absorber that adsorbs or absorbs carbon dioxide from exhaust gas;
a regeneration column that is connected with the absorption column and includes an adsorbent heater that heats an adsorbent circulating therein or an absorbent heater that heats an absorbent circulating therein; and
an adsorbent or an absorbent that alternately performs adsorption of carbon dioxide and desorption of carbon dioxide or absorption of carbon dioxide and desorption of carbon dioxide while circulating through the absorption column and the regeneration column,
wherein the apparatus is configured to diverge from a first equalizing gas line, which connects a line for carbon dioxide desorbed through the regeneration column and an absorption column hopper, and supply low-concentration oxygen gas to the absorption column hopper.

10. The apparatus of claim 9, wherein gas partially diverges after passing through a first valve from the first equalizing gas line at the upper end of the absorption column hopper, sequentially passes through a first particle filter and a first pressure booster, and is then reused as a fluidizing gas at a lower portion of the absorption column hopper through a first flowmeter, and
some new fluidizing gas may be fed at a outlet line of the first pressure booster for an insufficient fluidizing gas of the absorption column hopper.

11. A process for capturing of carbon dioxide that comprising: adsorbing carbon dioxide or absorbing carbon dioxide from exhaust gas at an absorption column; and alternately performing adsorption of carbon dioxide and desorption of carbon dioxide or absorption of carbon dioxide and desorption of carbon dioxide while an adsorbent or an absorbent circulates in a regeneration column and the absorption column that include a heater for heating the adsorbent or the absorbent circulating therein,
wherein gas diverges from a first equalizing gas line, which connects a line for carbon dioxide desorbed through the regeneration column and an absorption column hopper, to supply low-concentration oxygen gas to the absorption column hopper, and
gas diverges from a second equalizing gas line, which connects a line for discharging exhaust gas with carbon dioxide removed that is discharged outside through an upper end of the absorption column and a regeneration column hopper, to supply low-concentration oxygen gas to the regeneration column hopper.

12. A process for capturing of carbon dioxide that comprising: adsorbing carbon dioxide or absorbing carbon dioxide from exhaust gas at an absorption column; and alternately performing adsorption of carbon dioxide and desorption of carbon dioxide or absorption of carbon dioxide and desorption of carbon dioxide while an adsorbent or an absorbent circulates in a regeneration column and the absorption column that include a heater for heating the adsorbent or the absorbent circulating therein,
wherein gas diverges from a first equalizing gas line, which connects a line for carbon dioxide desorbed through the regeneration column and an absorption column hopper, to supply low-concentration oxygen gas to the absorption column hopper.
